(19) United States
(12) Patent Application Publication
(10) Pub. No.: US 2012/0040700 A1
(43) Pub. Date: Feb. 16, 2012

(54) GROUP PAGING FOR MACHINE-TYPE COMMUNICATIONS

(75) Inventors: Sylvie Gomes, Douglaston, NY (US); Diana Pani, Montreal (CA); Bhaskar M. Anepu, Lancaster, PA (US); Paul Marinier, Brossard (CA)

(73) Assignee: InterDigital Patent Holdings, Inc., Wilmington, DE (US)

(21) Appl. No.: 13/025,502

(22) Filed: Feb. 11, 2011

Related U.S. Application Data
(60) Provisional application No. 61/303,880, filed on Feb. 12, 2010.

(51) Int. Cl. H04B 7/00

(52) U.S. Cl. 455/500

(57) ABSTRACT

Methods and apparatus are provided for performing group-based machine-to-machine (M2M) communication. Machine-type communication (MTC) wireless transmit/receive units (WTRUs) may operate in M2M groups. A group of MTC WTRUs may be paged collectively as a group. An MTC WTRU may store an individual international mobile subscriber identity (IMSI) associated with the MTC WTRU, and a group-based IMSI associated with the MTC group that the MTC WTRU belongs to. The MTC WTRU may use one or both IMSIs to receive paging messages. When the MTC WTRU receives a paging message, the MTC WTRU may compare a recipient IMSI contained in the paging message to the individual IMSI and the group-based IMSI. If the recipient IMSI matches the individual IMSI and the group-based IMSI, the MTC WTRU may proceed to process the paging message.

### CROSS-REFERENCE TO RELATED APPLICATIONS

This application claims the benefit of U.S. Provisional Application No. 61/303,880 filed on Feb. 12, 2010, which is incorporated herein by reference as if fully set forth.

### BACKGROUND

Machine to Machine (M2M) communication (also referred to as “machine-type communications” or “MTC”) may be seen as a form of data communication between entities that do not necessarily need human interaction.

M2M communication may be used in a variety of areas. In the area of security, M2M communication may be used in surveillance systems, in backup of telephone landlines, in the control of physical accesses (e.g. to buildings), and in car/driver security. In the area of tracking and tracing, M2M communication may be used for fleet management, order management, Pay As You Drive (PAYD) applications, asset tracking, navigation, traffic information applications, road tolling, traffic optimization, and steering. In the area of payment systems, M2M communication may be used in point of sales, vending machines, customer loyalty applications, and gaming machines. In healthcare, M2M communication may be used for remotely monitoring vital signs, supporting the elderly or handicapped, in web access telemedicine points, and in remote diagnostics. In the area of remote maintenance/control, M2M communication may be used in programmable logic controllers (PLCs), sensors, lighting, pumps, valves, elevator control, vending machine control, and vehicle diagnostics. In the area of metering, M2M communication may be used in applications related to power, gas, water, heating, grid control, and industrial metering. Additionally, M2M communication based on machine type communication (MTC) technology may be used in areas such as customer service.

M2M communications may take advantage of deployed wireless networks based on Third Generation Partnership Project (3GPP) technologies such as Global System for Mobile Communications (GSM), Universal Mobile Telecommunications System (UMTS), Long Term Evolution (LTE), and/or other technologies such as those developed by the Institute for Institute of Electrical and Electronics Engineers (IEEE) and 3GPP2. M2M communications may use networks based on these technologies to deliver business solutions in a cost-effective manner. In a circumstance involving ubiquitous deployment of wireless networks, the availability of the wireless networks may facilitate and/or encourage the deployment and use of MTC devices. Additionally, further enhancements to these technologies may provide additional opportunities for the deployment of M2M-based solutions.

Current M2M-based solutions do not adequately address potential congestions on the network that may be caused by a large number of MTC devices performing network registration and/or transmitting data simultaneously. Accordingly, new technology that overcomes this shortcoming in the current technology is needed.

### SUMMARY

Methods and apparatus are provided for performing group-based machine-to-machine (M2M) communication. Machine-type communication (MTC) wireless transmit/receive units (WTRUs) may operate in M2M groups. In an embodiment, MTC WTRUs may be organized into groups based on shared features. A group of MTC WTRUs may be paged collectively as a group. An MTC WTRU may use an individual International Mobile Subscriber Identity (IMSI) for receiving pages individually and a groupIMSI for receiving pages as part of a group.

In an embodiment, an MTC WTRU may store an individual international mobile subscriber identity (IMSI) associated with the MTC WTRU, and a group-based IMSI associated with the MTC group that the MTC WTRU belongs to. The MTC WTRU may use one or both IMSIs to receive paging messages. When the MTC WTRU receives a paging message, the MTC WTRU may compare a recipient IMSI contained in the paging message to the individual IMSI and the group-based IMSI. If the recipient IMSI matches the individual IMSI or the group-based IMSI, the MTC WTRU may proceed to process the paging message.

The MTC WTRUs in the MTC group that are paged collectively as group may respond according to staggered time windows. For example, a group paging message may indicate a time period for the plurality of MTC WTRUs to transmit data. The MTC WTRU may select a random value, and may determine a sub-time period within the time period based on the random value. The MTC WTRU may respond to the group paging message during the determined sub-time period. For example, the MTC WTRUs in the MTC group may transmit data in their respective staggered sub-time periods.

In an embodiment, the MTC WTRU may process a paging message addressed to the MTC group. The MTC WTRU may determine whether to respond to the group paging message. For example, a subset of the MTC WTRUs may respond to the group paging message, and the MTC WTRU may not respond such that network congestion may be avoided or reduced.

### BRIEF DESCRIPTION OF THE DRAWINGS

A more detailed understanding may be had from the following description, given by way of example in conjunction with the accompanying drawings.

FIG. 1A is a system diagram of an example communications system in which one or more disclosed embodiments may be implemented.

FIG. 1B is a system diagram of an example wireless transmit/receive unit (WTRU) that may be used within the communications system illustrated in FIG. 1A.

FIG. 1C is a system diagram of an example radio access network and an example core network that may be used within the communications system illustrated in FIG. 1A.

FIG. 1D is a system diagram of an example radio access network and an example core network that may be used within the communications system illustrated in FIG. 1A.

FIG. 1E is a system diagram of an example radio access network and an example core network that may be used within the communications system illustrated in FIG. 1A.

FIG. 2 shows example architecture for MTC communication that includes an MTC server inside an operator domain.

FIG. 3 shows example architecture for MTC communication that includes an MTC server located outside of an operator domain.

FIG. 4 shows example architecture for MTC WTRU communication wherein MTC WTRUs communicate directly without an intermediate MTC server.

FIG. 5 shows an example architecture for MTC WTRU communication.

FIGS. 6-8 illustrate example process for MTC communication.

### DETAILED DESCRIPTION OF ILLUSTRATIVE EMBODIMENTS

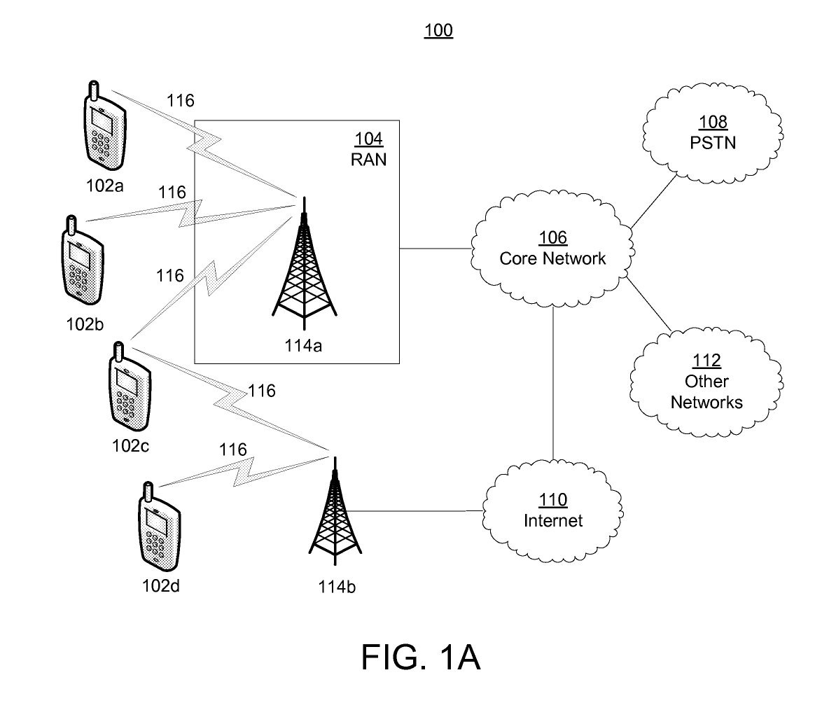

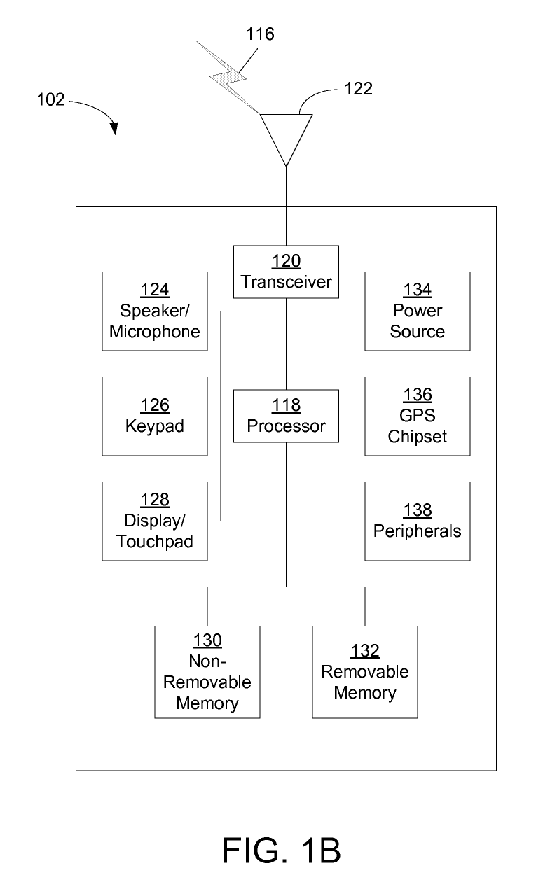

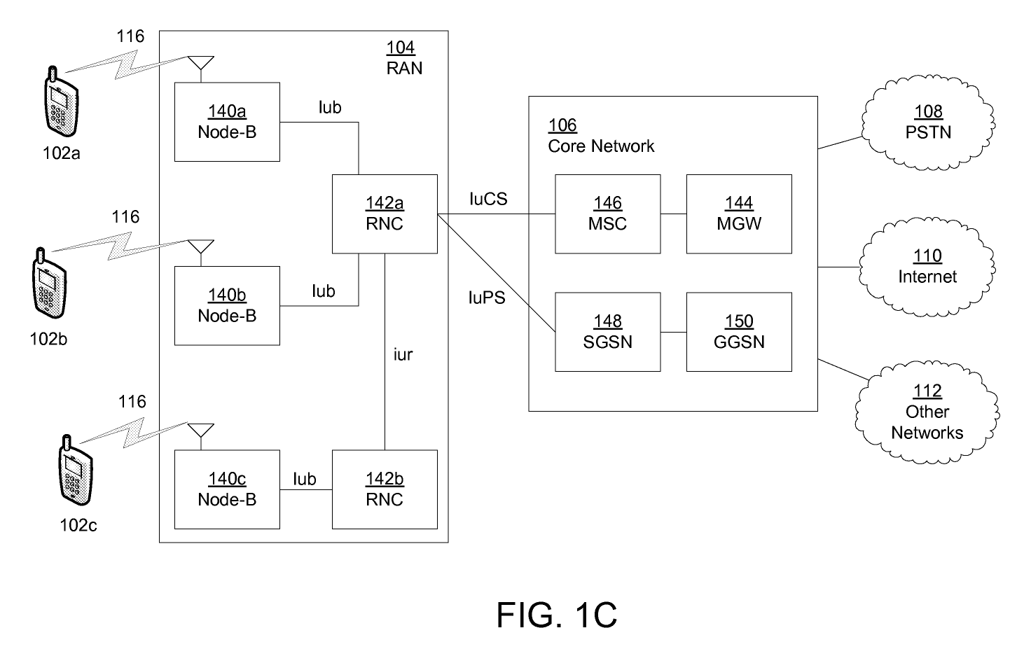

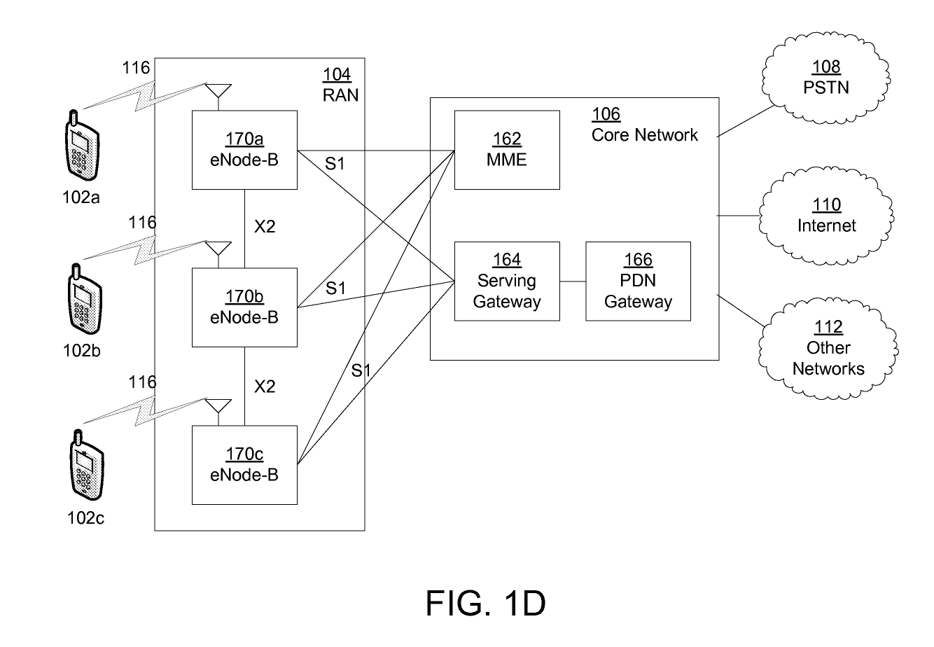

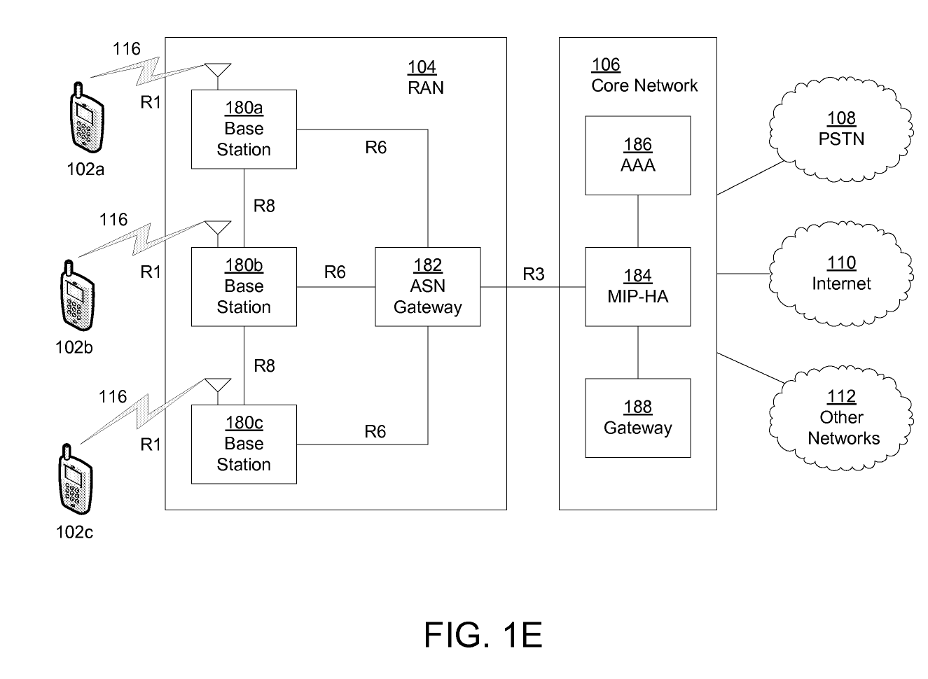

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in an embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In an embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The core network 106 may include at least one transceiver and at least one processor. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, memory. For example, memory may include any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is physically located remote from the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ a UTRA radio technology to communicate with the WTRUs 102a, 102b and 102c over the air interface 116. The RAN 104 may also be in communication with the core network 106. As shown in FIG. 1C, the RAN 104 may include Node-Bs 140a, 140b, 140c, which may each include one or more transceivers for communicating with the WTRUs 102a, 102b, 102c over the air interface 116. The Node-Bs 140a, 140b, 140c may each be associated with a particular cell (not shown) within the RAN 104. The RAN 104 may also include RNCs 142a, 142b. It will be appreciated that the RAN 104 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 104 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 104 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 170a, 170b, 170c, though it will be appreciated that the RAN 104 may include any number of eNode-Bs while remaining consistent with an embodiment. The eNode-Bs 170a, 170b, 170c may each include one or more transceivers for communicating with the WTRUs 102a, 102b, 102c over the air interface 116. In an embodiment, the eNode-Bs 170a, 170b, 170c may implement MIMO technology. Thus, the eNode-B 140a, for example, may use multiple antennas to transmit wireless signals to, and receive wireless signals from, the WTRU 102a.

Each of the eNode-Bs 170a, 170b, 170c may be associated with a particular cell (not shown) and may be configured to handle radio resource management decisions, handover decisions, scheduling of users in the uplink and/or downlink, and the like. As shown in FIG. 1D, the eNode-Bs 170a, 170b, 170c may communicate with one another over an X2 interface.

The core network (CN) 106 shown in FIG. 1D may include a mobility management gateway (MME) 162, a serving gateway 164, and a packet data network (PDN) gateway 166. While each of the foregoing elements are depicted as part of the core network 106, it will be appreciated that any one of these elements may be owned and/or operated by an entity other than the core network operator.

The MME 162 may be connected to each of the eNode-Bs 170a, 170b, 170c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode Bs 170a, 170b, 170c in the RAN 104 via the Si interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

FIG. 1E is a system diagram of the RAN 104 and the core network 106 according to an embodiment. The RAN 104 may be an access service network (ASN) that employs IEEE 802.16 radio technology to communicate with the WTRUs 102a, 102b, 102c over the air interface 116. As will be further discussed below, the communication links between the different functional entities of the WTRUs 102a, 102b, 102c, the RAN 104, and the core network 106 may be defined as reference points.

As shown in FIG. 1E, the RAN 104 may include base stations 180a, 180b, 180c, and an ASN gateway 142, though it will be appreciated that the RAN 104 may include any number of base stations and ASN gateways while remaining consistent with an embodiment. The base stations 180a, 180b, 180c may each be associated with a particular cell (not shown) in the RAN 104 and may each include one or more transceivers for communicating with the WTRUs 102a, 102b, 102c over the air interface 116. In one embodiment, the base stations 180a, 180b, 180c may implement MIMO technology. Thus, the base station 140a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 106, and the like.

The air interface 116 between the WTRUs 102a, 102b, 102c and the RAN 104 may be defined as an R1 reference point that implements the IEEE 802.16 specification. In addition, each of the WTRUs 102a, 102b, 102c may establish a logical interface (not shown) with the core network 106. The logical interface between the WTRUs 102a, 102b, 102c and the core network 106 may be defined as an R2 reference point, which may be used for authentication, authorization, IP host configuration management, and/or mobility management. The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 215 may be defined as an R6 reference point. The R6 reference point may include protocols for facilitating mobility management based on mobility events associated with each of the WTRUs 102a, 102b, 100c.

As shown in FIG. 1E, the RAN 104 may be connected to the core network 106. The communication link between the RAN 104 and the core network 106 may defined as an R3 reference point that includes protocols for facilitating data transfer and mobility management capabilities, for example. The core network 106 may include a mobile IP home agent (MIP-HA) 184, an authentication, authorization, accounting (AAA) server 186, and a gateway 188. While each of the foregoing elements are depicted as part of the core network 106, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 1E, it will be appreciated that the RAN 104 may be connected to other ASNs and the core network 106 may be connected to other core networks. The communication link between the RAN 104 the other ASNs may be defined as an R4 reference point, which may include protocols for coordinating the mobility of the WTRUs 102a, 102b, 102c between the RAN 104 and the other ASNs. The communication link between the core network 106 and the other core networks may be defined as an R5 reference, which may include protocols for facilitating interworking between home core networks and visited core networks.

A “MTC WTRU” or a “M2M WTRU” may include a WTRU capable of communicating using MTC/M2M technology. For example, the MTC WTRU and/or M2M WTRU, may include a WTRU, such as the one described in connection with FIGS. 1A-E, capable of communicating using MTC/M2M technology. For example, an MTC WTRU may include an MTC device.

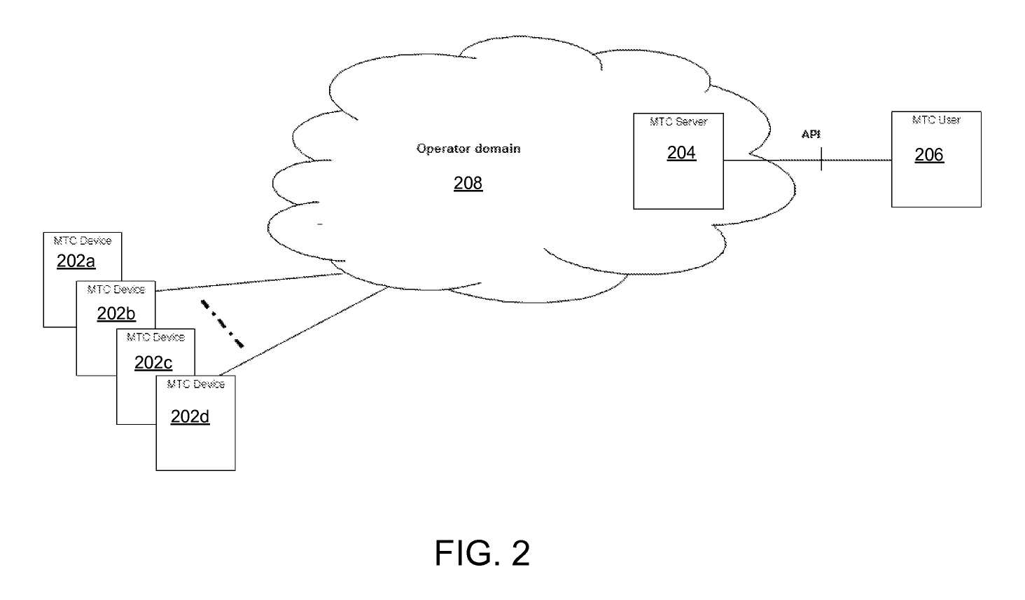

FIG. 2 illustrates example architecture for use in MTC communication. As shown, one or more MTC devices such as MTC devices 202a, 202b, 202c and 202d may communicate to one or more MTC servers such as MTC server 204 via an operator domain such as operator domain 208. As shown in FIG. 2, the MTC server 204 may be located in the operator domain 208, for example. MTC users such as MTC user 206 may access the MTC server 204, for example, via an application protocol interface (API) such that the MTC user may communicate with MTC devices 202a, 202b, 202c.

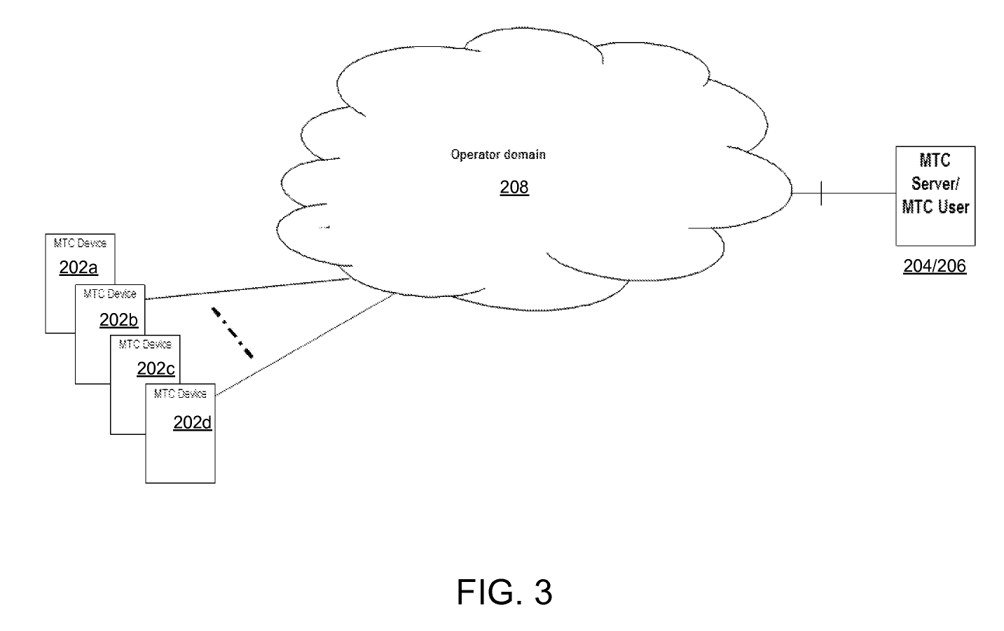

FIG. 3 illustrates example architecture for use in MTC communication. As shown, one or more MTC devices such as MTC devices 202a, 202b, 202c and 202d may communicate to one or more MTC servers such as MTC server 204 and/or one or more MTC users such as MTC user 206 via an operator domain such as operator domain 208. The MTC server 204 may be located in the operator domain 208, for example. MTC users such as MTC user 206 may access the MTC server 204, for example, via an application protocol interface (API) such that the MTC user may communicate with MTC devices 202a, 202b, 202c. As shown in FIG. 3, the MTC server 204 may be located outside of the operator domain 208.

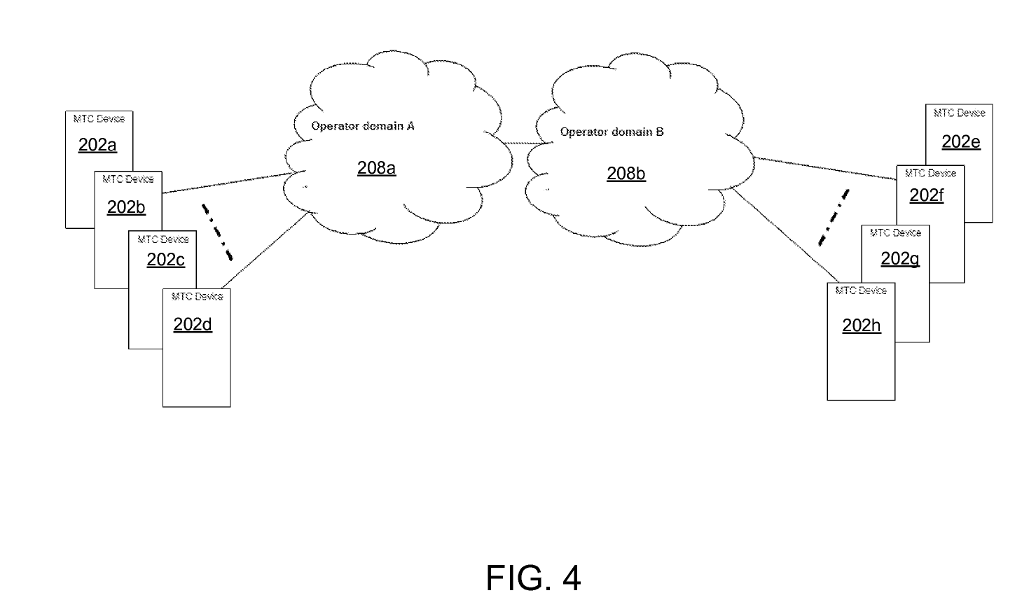

FIG. 4 illustrates example architecture for use in MTC communication. As shown, MTC devices communicate with each other (MTC-MTC communication) without an intermediary MTC server. For example and as shown in FIG. 4, one or more MTC devices such as MTC devices 202a, 202b, 202c and 202d may communicate to one or more MTC devices 202d, 202e, 202f and 202g via multiple operator domains such as operator domains 208a and 208b. As shown in FIG. 4, operator domains 208a and 208b may be operatively connected to each other such that MTC devices connected to operator domain 208a may communicate to MTC devices connected to operator domain 208b, and vice versa.

In an embodiment, an MTC group may be defined based on one or more shared features among MTC WTRUs. Features that may be used to determine whether WTRUs may be classified as a group may include but are not limited to: whether MTC WTRUs use a same or similar application, whether MTC WTRUs are time-controlled MTC WTRUs (e.g. MTC WTRUs that may send and/or receive data at pre-defined periods), whether WTRUs are mobile-originated-only MTC WTRUs (e.g. MTC WTRUs that may send data but will not receive data in the normal course of operation), whether MTC WTRUs are time-tolerant WTRUs (e.g. WTRUs that may be permitted to delay transmission of data), whether WTRUs are low-mobility WTRUs (e.g. MTC WTRUs that may not frequently move and/or may not move at high speeds), whether MTC WTRUs are not-mobile WTRUs (e.g. MTC WTRUs that may stay in the same location), and/or other features. The MTC WTRUs in a group may share multiple features at the same time.

In an embodiment, MTC WTRUs belonging to the same cell may be grouped into an MTC group. In an embodiment, MTC WTRUs located in the same geographic area may be grouped into an MTC group. For example, utility meters within a neighborhood may be grouped into an MTC group.

To send a page to WTRUs in a group, different paging messages may be used. For example, in a Universal Mobile Telecommunications System/UMTS Terrestrial Radio Access Network (UTRAN) system, Paging Type 1 or other paging messages may be used. In an LTE/E-UTRAN system, Paging Type 1 or other paging messages may be used. In a UTRAN system, a Paging Type 1 message may include eight paging records. In an E-UTRAN system, a Paging Type 1 message may include sixteen paging records. To page a group of MTC WTRUs in a UTRAN or E-UTRAN system, paging messages may be sent to each of the MTC WTRUs in the group, with each paging record addressed to a different WTRU in the group.

In an embodiment, the network may page multiple MTC WTRUs via a group paging message. For example, one paging record may be used to page multiple MTC WTRUs in an MTC group. A group paging message may include multiple paging records. Each paging record may be addressed to a different MTC group. The number of MTC WTRUs that may be simultaneously paged may be based on the maximum number of WTRUs that can belong to an MTC group multiplied by the maximum number of paging records carried by a paging message.

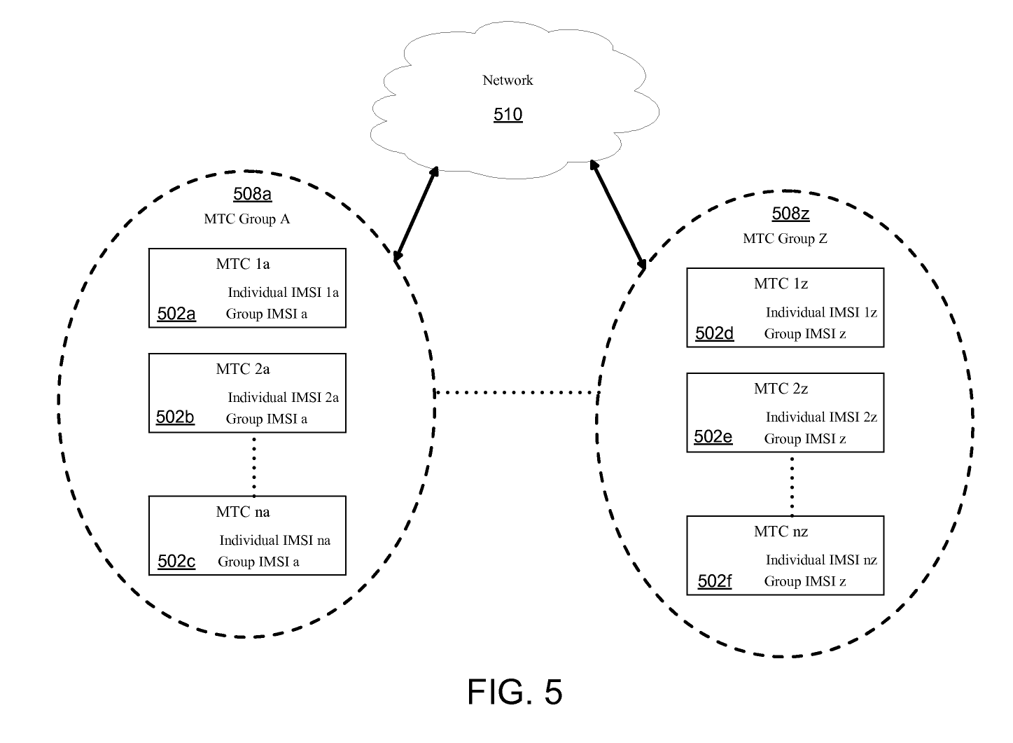

FIG. 5 illustrates example architecture for MTC group paging. As shown, pages may be sent to MTC groups, such as MTC group A 508a, MTC group Z 508z, and/or other MTC groups (not shown) via a communication network such as network 510. Network 510 may include a radio access network (RAN) 104, a core network 106, a public switched telephone network (PSTN) 108, the Internet 110, and other networks 112 as described above with respect to FIGS. 1C-1E.

An MTC group may include one or more MTC WTRUs. As shown in FIG. 5, MTC group A 508a may include multiple MTC WTRUs such as MTC 1a 502a, MTC 2a 502b, MTC na 502c, and other MTC WTRUs (not shown). MTC group Z 508z may include multiple MTC WTRUs such as MTC 1z 502d, MTC 2z 502e, MTC nz 502f, and other MTC WTRUs (not shown). MTC WTRUs 502 may include an MTC device 202 as described above with respect to FIGS. 2-4.

MTC WTRUs in an MTC group may share a group-based International Mobile Subscriber Identity (IMSI) that may be referred to as “groupIMSI” herein. A groupIMSI may uniquely identify the MTC group. As shown in FIG. 5, for example, MTC WTRUs 502a-c of MTC group A 508a may share a group IMSI such as group IMSI a. MTC WTRUs 502d-e of MTC group Z 508z may share a group IMSI such as group IMSI z. Each MTC WTRU 502 may be associated with an individual IMSI. For example, MTC WTRU 502a may be associated with IMSI 1a, MTC WTRU 502b may be associated with IMSI 2a, and MTC WTRU 502c may be associated with IMSI na. MTC WTRU 502d may be associated with IMSI 1z, MTC WTRU 502e may be associated with IMSI 2z, and MTC WTRU 502f may be associated with IMSI nz.

In an embodiment, a group of MTC WTRUs 502 may be paged using a group identifier, a groupIMSI or the like that may uniquely identify the MTC group 508. MTC WTRUs 502 in a group 508 may be assigned with a groupIMSI. The groupIMSI may be used for receiving pages addressed to the group 508, such as group paging messages.

For example, the MTC WTRU 502 may store one or more groupIMSIs associated with the MTC group(s) that the MTC WTRU 502 belong to in a memory such as Subscriber Identity Module (SIM) card/Universal Subscriber Identity Module (USIM) card or other card, in a memory device such as a Random Access Memory (RAM), and/or in any other processor-readable storage medium.

The MTC WTRU 502 may use an individual IMSI for receiving paging messages addressed to the specific MTC WTRU 502. The individual IMSI may be stored in a memory such as Subscriber Identity Module (SIM) card/Universal Subscriber Identity Module (USIM) card or other card, in a memory device such as a Random Access Memory (RAM), and/or in any other processor-readable storage medium.

In an embodiment, groupIMSI may include a fixed value. In an embodiment, groupIMSI may include a variable. For example, groupIMSI may be initialized and updated via communications with network 510. The MTC WTRUs 502 in an MTC group 508 may have their groupIMSI values updated by network 510. For example, a new groupIMSI value may be communicated by network 510 to the MTC WTRUs 502 via messages such as Non Access Stratum (NAS) messages. For example, a message such as GROUP IMSI REALLOCATION COMMAND message may be used for to update groupIMSI. For example, a field in the TMSI REALLOCATION COMMAND message may be used to indicate a new groupIMSI value to the MTC WTRUs 502. The field may be referred to, for example, a “Group Mobile Identity” field. When an MTC group 508 receives a new groupIMSI value, one or more MTC WTRUs 502 in the group may respond by transmitting one or more acknowledgement messages, such as a GROUP IMSI REALLOCATION COMPLETE message.

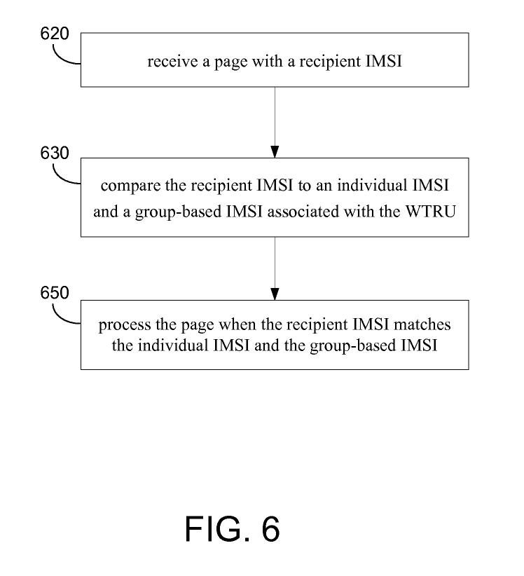

FIG. 6 illustrates an example process for MTC communication. At 620, the MTC WTRU 502 may receive a paging message that may include a recipient IMSI. At 630, the MTC WTRU 502 may compare the recipient IMSI to the individual IMSI and the groupIMSI associated with the MTC WTRU 502. At 650, the MTC WTRU 502 may determine whether to process the paging message. For example, when the recipient IMSI matches the individual IMSI and/or the group-based IMSI, the MTC WTRU 502 the MTC WTRU 502 may determine that the paging message is addressed to the MTC WTRU 502, and may proceed to process the paging message.

In an embodiment, a temporary groupIMSI may be allocated to the WTRUs 502 in an MTC group 508. The temporary groupIMSI may be associated with the WTRUs 502 that may share a groupIMSI.

For example, when an MTC WTRU 502 may receive a paging message that may include a groupIMSI and/or a temporary groupIMSI. The MTC WTRU 502 may include the groupIMSI and/or temporary groupIMSI in a message responsive to the paging message. The message responsive to the paging message may include one or more fields that may include identifying information related specifically to the MTC WTRU 502. The identifying information may include as an IMSI field, a Temporary Mobile Subscriber Identity (TMSI) field, a Serving Temporary Mobile Subscriber Identity (S-TMSI) field, and/or other fields. The information sent in the message responsive to the paging message may be configured via signaling between a MTC WTRU 502 and network 510. The message response to the paging message may be, for example, a Radio Resource Control (RRC) Connection Request message in response to a paging message.

In an embodiment, an IMSI may be used by an MTC WTRU 502 to determine a paging occasion when the WTRU may listen for paging messages. For example, the WTRU 502 may use an IMSI to determine when paging frames may be available for reception. The MTC WTRUs 502 in an MTC group 508 may use a groupIMSI associated with the group to determine when paging frames and/or paging occasions may occur. The MTC WTRUs 502 may receive paging messages at the times that may be determined based on the groupIMSI. For example, the MTC group 508 may listen for the paging message simultaneously during a paging occasion. When network 510 sends a single paging message, the paging message may be received by the MTC WTRUs 502 in the MTC group 508.

The value of a paging occasion may be may be determined as follows. Paging Occasion={(groupIMSI div K) mod (DRX cycle length div PBP)}*PBP+n*DRX cycle length+Frame Offset, where n=0, 1, 2 . . . as long as System Frame Number (SFN) is below its maximum value, and where K is equal to the number of listed Secondary Common Control Physical Channels (SCCPCHs) which carry a paging channel (PCH). PBP may represent Paging Block Periodicity (PBP) and DRX cycle length may represent a Discontinuous Reception (DRX) cycle length. For example, in Frequency Division Duplex (FDD) systems, PBP may be equal to one.

A Paging Indicator (PI) may be sent on a Paging Indicator Channel (PICH) to indicate that a paging message is being transmitted on a PCH. For example, a paging indicator (PI) may be determined based on PI=DRX index mod Np, where Np indicates the number of PIs per radio frame, and where DRX index=groupIMSI div 8192.

In an embodiment, a UE_ID parameter may be used to determine paging frames and/or paging occasions. A UE_ID parameter may be determined according to UE_ID=groupIMSI mod 1024.

The MTC WTRUs 502 in the MTC group 508 may use a groupIMSI to select an SCCPCH. For example, the MTC WTRUs 502 in a group may select the same SCCPCH. The SCCPCH may be selected from the SCCPCHs listed in one or more messages received by the MTC group 508, such as System Information Block (SIB) messages. SCCPCHs may be listed in, for example, SIB5 or SIB5bis messages. The MTC group 508 may select the SCCPCH from the one or more SCCPCHs listed in a SIB5, SIB5bis, or other message. For example, the SCCPCH may be selected as follows:

index of selected SCCPCH=groupIMSI mod K, where K is equal to the number of listed SCCPCHs which carry a PCH.

In an embodiment, the MTC WTRUs 502 in an MTC group 508 may be associated with a range of IMSI values. For example, IMSI values may be split into different ranges, and each range of IMSI values may correspond to an MTC group. In an embodiment, twenty-one bits may be allocated for the IMSI. The first fifteen bits may be used to indicate IMSI values, and the final six bits of the twenty-one bits may be allocated to indicate group ranges.

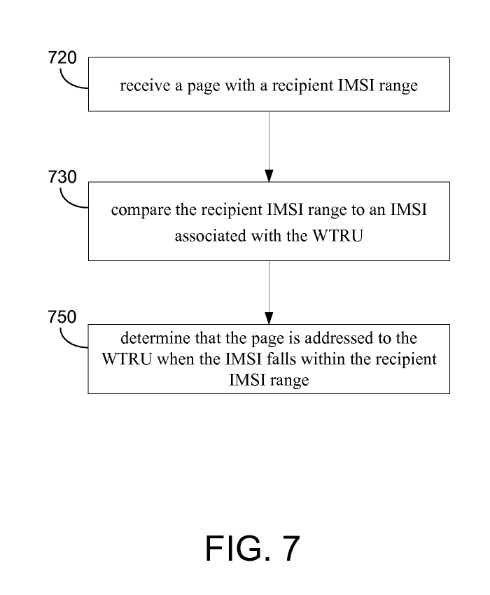

FIG. 7 illustrates an example process for MTC communication. At 720, the MTC WTRU 502 may receive a paging message that may include a recipient IMSI range.

In an embodiment, the paging message may include one or more fields that indicate the beginning and/or end of the IMSI range. For example, an Information Element (IE) may be used to indicate the IMSI range. The IE may be referred to, for example, an “IMSI range” field. The IE may include two sub-IEs, one may indicate a starting IMSI or the lowest value in the IMSI range, and another may indicate an ending IMSI or the highest value in the IMSI range. The sub-IEs may be referred to as, for example, “IMSI start” and “IMSI end.” Other configurations of IEs and/or other fields may indicate information associated with the recipient IMSI range. The recipient IMSI range information may be included in, for example, a paging record in a paging message.

As shown in FIG. 7, at 730, the MTC WTRU 502 may compare the recipient IMSI range to the IMSI associated with the MTC WTRU 502. For example, when an MTC WTRU 502 receives a paging message with IMSI range information, the MTC WTRU 502 may determine whether the IMSI associated with the MTC WTRU 502 falls within the specified range. At 750, the MTC WTRU 502 may determine that the paging message is addressed to the MTC WTRU 502 when the recipient IMSI falls within the recipient IMSI range. If the IMSI falls within the IMSI range, the MTC WTRU 502 may process the paging message and proceed according to the information indicated in the paging message.

The MTC WTRUs 502 in MTC group 508 may use the same paging occasions. The MTC WTRUs 502 may use a common value for calculating the paging occasion. For example, the MTC WTRUs 502 in an MTC group 508 may use a common value that may be referred to as “commonIMSI.” The commonIMSI may be used as the IMSI value in the formulas used for determining a PI, a SCCPCH, and/or a UE_ID as described above. The value for the commonIMSI may be, for example, a predetermined value, a value indicating the lowest value in the IMSI range, an IMSI value in the middle of the IMSI range, a medium IMSI of the IMSI range, and/or a value indicating the highest value in the IMSI range. In an embodiment, the commonIMSI value may be indicated to the WTRUs 502 in the MTC group 508 via signaling from network 510. The commonIMSI signaled by network 510 may be, for example, an IMSI value or an index on an IMSI in the IMSI range. In an embodiment, the commonIMSI may be determined based on one or more values related to the IMSI range. For example, the common value may be determined based on the following formula:

commonIMSI=(IMSI end−IMSI start)/2,

where IMSI end is the highest value in the IMSI range, and

where IMSI start is the lowest value in the IMSI range.

In an embodiment, Temporary Mobile Subscriber Identity (TMSI), Packet-Temporary Mobile Subscriber Identity (P-TMSI), and/or S-TMSI values may be communicated using ranges, using similar mechanisms, mutatis mutandis, as those described above with reference to IMSI ranges.

When an MTC WTRU 502 receives a paging message, the MTC WTRU 502 may attempt to respond to the received paging message. In an embodiment, when a group of MTC WTRUs 502 receives a group paging message, the MTC WTRUs 502 in the group may attempt to respond to the group paging message at the same time. In an embodiment, the timing for the WTRUs 502 in an MTC group 508 to respond to a group paging message may be controlled such that the risk of network congestions may be reduced.

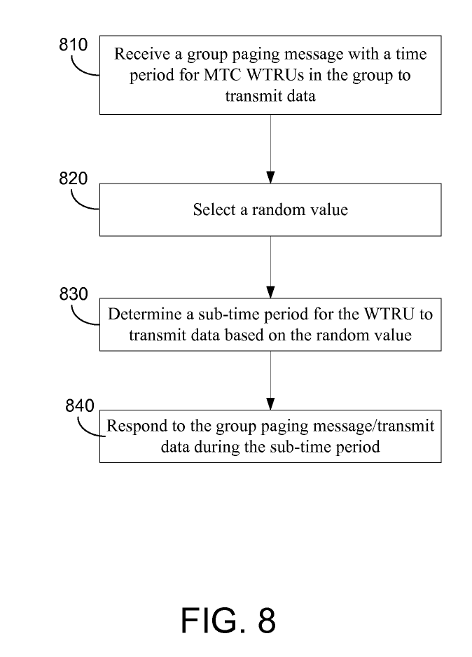

FIG. 8 illustrates an example process for MTC communication. At 810, the MTC WTRU 502 may receive a paging message that may include a time period for the MTC WTRUs 502 in the MTC group 508 to transmit data. At 820, the MTC WTRU 502 may select a random value. At 630, the MTC WTRU 502 may determine a sub-time period for the MTC WTRU 502 to transmit data based on the random value. At 840, the MTC WTRU 502 may respond to the group paging message and/or transmit data during the determined sub-time period.

For example, network 510 may determine a maximum period of time during which the MTC WTRUs 502 in an MTC group 508 may respond to a paging message. The maximum period of time may be referred to as “Tmax” herein. The Tmax value may be included in a group paging message sent to the MTC WTRUs 502 in the MTC group 508. Upon reception of the group paging message, an MTC WTRU 502 in the group may select a random value, for example, between zero and Tmax. The MTC WTRU 502 may respond to the paging message at a time corresponding to the selected value.

In an embodiment, a paging message may include a Tmax value, and/or a field indicative of a number of sub-periods that may be referred to as “Nsp” herein. An MTC WTRU 502 may select a random value between zero and Nsp. The MTC WTRU 502 may respond to the paging message at a time corresponding to the selected value.

In an embodiment, an MTC WTRU 502 may use a persistency value, such as value P, to determine whether it is permitted to respond to a paging message. The MTC WTRU 502 may select a random number, such as value R, between zero and one. The MTC WTRU 502 may determine whether to respond to the group paging message by comparing P and R. For example, if R is less than P, the MTC WTRU 502 may determine that the MTC WTRU 502 may respond to the paging message. Otherwise, the WTRU may wait for a period of time, such as a “backoff time” period, before determining again whether to the MTC WTRU 502 may respond to the group paging message. Once the backoff time period expires, the MTC WTRU 502 may select a new random value R. The MTC WTRU 502 may compare the new R to P to determine whether to respond to the group paging message. The process described above may be repeated until the WTRU has responded to the paging message.

In an embodiment, the persistency value P may be a predefined value, and/or may be signaled to the MTC WTRU 502 from network 510. For example, the value for P may be pre-signaled to the MTC WTRU 502 in, for example, a System Information message. In an embodiment, P may be determined based on an IMSI, TMSI, or S-TMSI value, or may be based on function of an IMSI, TMSI, or S-TMSI value. For example, P may be determined based on an IMSI, TMSI, and/or S-TMSI value and a time parameter. The time parameter value may be, for example, a system frame number obtained by the WTRU in, for example, a System Information message. By basing P on an IMSI, TMSI, or S-TMSI value, different WTRUs may be provided faster access times to respond to paging messages at different periods of time.

For example, the persistency value P may be indicated or included in the paging message. For example, a group paging message may include an index to a pre-defined or pre-signaled set of possible P values. The group paging message may indicate a number of WTRUs or an index to a pre-defined or pre-signaled range of WTRU numbers. An MTC WTRU 502 may determine the value P and/or a backoff time based on the indicated number of WTRUs and/or the indicated index value. For example, the MTC WTRU 502 may determine the persistency value P based on the indicated number of WTRUs. The MTC WTRU 502 may determine a backoff time period by multiplying a number by the indicated number of WTRUs.

In an embodiment, MTC WTRUs 502 in an MTC group 508 may be divided into sub-groups. Each sub-group may use a different time period to respond to the paging message. For example, an MTC group 508 may contain N MTC WTRUs 502. The N WTRUs may be divided into M sub-groups, with N/M WTRUs in each sub-group. The value of M may be a function of N, may depend on available bandwidth and/or the amount of data to transmit, may be a fixed value, and/or may be signaled to the MTC WTRUs 502 in the MTC group 508 by network 510. For example, a first sub-group of MTC WTRUs 502, or the first N/M WTRUs, may respond to the paging message in a first pre-determined number of seconds. A second sub-group of MTC WTRUs 502, or the second N/M WTRUs 502, may respond to the paging message in a subsequent second pre-determine number of seconds, and so on, until the final N/M WTRUs have responded. To illustrate, the first N/M WTRUs may respond to the paging message between second 0 to second Y, the second N/M WTRUs may respond to the paging message between second Y and second 2Y, and so on, until the final N/M WTRUs have responded.

The MTC WTRUs 502 may use an IMSI value to divide WTRUs into sub-groups. For example, as described above, the WTRUs 502 may receive group paging messages via IMSI ranges. The IMSI range that corresponds to an MTC group 508 may be divided into sub-ranges. An MTC WTRU 502 may determine its transmission time based on which sub-group the IMSI of the WTRU belongs to. The values that indicate the IMSI sub-ranges may be signaled to the WTRUs 502 in the MTC group 508 from network 510, may be determined by dividing the IMSI range by a fixed value, may be determined by WTRUs individually, and/or may be included in the paging message.

In an embodiment, when MTC WTRUs 502 in an MTC group 508 receive a group paging message, a subset of the MTC WTRUs 502 in the group may to respond to the group paging message. For example, one or more MTC WTRUs 502 in the group may respond to the group paging message by sending an RRC request to the network 510.

The subset of MTC WTRUs 502 in the group that may respond to the group paging message may be determined. For example, an MTC WTRU 502 may be configured with default information that may indicate whether the MTC WTRU 502 should respond to a received MTC group paging message. The default information may be stored by the MTC WTRU 502 in a SIM/USIM card, in a RAM, and/or in any processor-readable storage medium.

For example, an MTC WTRU 502 may determine whether to respond to the group paging message, based on one or more parameters. The parameters may be include, but not limited to, the individual IMSI of the WTRU, the amount of data the WTRU has to respond to the message, the device type of the WTRU, the type of data the WTRU has to send in response to the message, the priority of the data the WTRU may send, and/or information contained in the paging message.

For example, the MTC WTRU 502 may determine to respond to the paging message based on information in the paging message. For example, the paging message may include an index that may specify whether the particular WTRU should respond to the paging message. The MTC WTRU 502 may compare the index to a second parameter to determine whether to respond to the paging message. The second parameter may be received by the MTC WTRU 502 from network 510, and/or be a pre-configured parameter.

When an MTC WTRU 502 in an MTC group 508 receives a paging message, the MTC WTRU 502 may determine whether to respond a group paging response message. The paging response message may reflect that the paging response message is sent in response to a group paging message. For example, the paging response message may include a group identity field that may include, for example, an IMSI, a groupIMSI, an IMSI range, TMSI, or S-TMSI and/or the like such that the MTC group 508 may be identified. The paging response may include a cause value that may indicate the sender is responding for a group of MTC WTRUs 502. For example, the MTC WTRU 502 may request RRC connection on behalf of the MTC WTRUs 502 belonging to the same MTC group 508. The MTC WTRU 502 may listen for and may receive an RRC connection setup message. The MTC WTRU 502 may transmit the RRC connection setup complete message.

For example, the MTC WTRU 502 may determine to not respond to the paging message based on information in the paging message. The MTC WTRU 502 may listen for an RRC connection setup message. For example, the MTC WTRU 502 may not transmit an RRC connection setup complete message.

Network 510, upon receipt of the response message, may determine based on the type of information included in the identity field whether the response message is an individual or a group response message. For example, if the identify field includes a groupIMSI or an IMSI range, network 510 may determine that the response message is a group response message. If the identity field includes an IMSI, network 510 may determine that the response message is an individual response message.

In an embodiment, upon a determination that the response message is a group response message, network 510 may consider the WTRUs 502 that belong to the MTC group 508 may be attempting to connect to the network 510. For example, when the network 510 may receive one or a subset of RRC connection request(s) from the MTC WTRUs 502 that belong to a particular MTC group 508, the network 510 may treat such request(s) as a connection request for the group. For example, the network 510 may treat such request(s) as if all the WTRUs 502 in the MTC group 508 have requested RRC connection.

For example, an IE in an RRC connection request may indicate whether the RRC connection request associated with an individual WTRU or associated with a group of WTRUs. For example, the IE may indicate to the network 510 that the WTRU sending the message is requesting a RRC connection. The IE may indicate to the network 510 that the WTRUs in the MTC group 508 that the sending WTRU belongs to are requesting RRC connection.

After transmitting the paging response message, the MTC WTRU 502 may perform a Random Access Channel (RACH) procedure. During the RACH procedure, the MTC WTRU 502 may receive one or more messages that may include a temporary Cell Radio Network Temporary Identifier (C-RNTI). This may be received in, for example, a RACH response message. The RACH response message may include an identifier of a preamble of a message transmitted by the WTRU. The preamble may have been included, for example, in the paging response message, in a message sent during the RACH procedure, and/or any other message.

In response to the paging response message, network 510 may send the MTC WTRU 502 an RRC connection setup message. The MTC WTRU 502 may use the temporary C-RNTI to receive the RRC connection setup message.

In an embodiment, the MTC WTRU 502 may receive the temporary C-RNTI in a way other than through the RACH procedure. The MTC WTRU 502 may receive the paging message and determine not to transmit a paging response message. The MTC WTRU 502 may not perform the RACH procedure, and may not have received the temporary C-RNTI during the RACH procedure.

For example, the MTC WTRU 502 may obtain the temporary C-RNTI in the paging message. The paging message may include a field that may contain a temporary C-RNTI value. The paging message may include an index that may indicate a specific temporary C-RNTI value among a set of pre-signaled possible values. The MTC WTRU 502 may monitor every RACH response message sent after the MTC WTRU 502 receives the paging message. The MTC WTRU 502 may store the temporary C-RNTI values that may be received in the RACH response messages. For example, the WTRU may listen for the RRC connection setup message on a Downlink Shared Channel (DL-SCH), using one or more of the stored temporary C-RNTI values.

For example, the MTC WTRU 502 may transport blocks, and compare fields in Media Access Control (MAC) control elements in the transport blocks to the identity of its MTC group and/or the temporary C-RNTI value. If data in a MAC control element matches the identity of the MTC group 508, the MTC WTRU 502 may determine that the transport block corresponds to the RRC connection setup message. If data in a MAC control element matches the temporary C-RNTI, the MTC WTRU 502 may determine that the transport block corresponds to the RRC connection setup message. After determining that a transport block corresponds to the RRC connection setup message, the MTC WTRU 502 may receive and process the RRC connection setup message contained in the transport block. The MTC WTRU 502 may receive a range of possible temporary C-RNTI values in one or more messages from network 510. This may reduce the number of possible temporary C-RNTI values. The one or more messages may include, for example, System Information messages.

For example, when an MTC WTRU 502 has not received an RRC connection setup message, the MTC WTRU 502 may transmit an RRC connection request message upon expiration of a timer and/or upon reception of the RRC Connection Setup message. In an embodiment, the MTC WTRU 502 may transmit an RRC connection request message even if the MTC WTRU 502 has transmitted an RRC connection request previously. The duration of the timer may be indicated, for example, in one or more messages received by the MTC WTRU 502 from network 510. The duration of the timer may be selected randomly up to a maximum value that may be provided by network 510. This may prevent multiple WTRUs having missed the RRC connection setup message from making such attempt at the same time. In an embodiment, there may be a maximum number of RRC connection attempts that the MTC WTRU 502 may make upon reception of a given paging message. After transmitting the RRC connection request message, the MTC WTRU 502 may receive the RRC connection setup message that is responsive to the RRC connection request message.

In an embodiment, network 510 may send an RRC connection setup message to the MTC WTRUs 502 in the MTC group 508 without having received an RRC Connection Request. For example, network 510 may send the RRC connection setup message after having paged the MTC WTRUs without having received any RRC Connection Request. Network 510 may obtain information that is usually conveyed to network 510 in an RRC Connection Request. For example, network 510 may obtain information such as the capabilities of an MTC WTRU via the subscription information associated with the MTC WTRU. For example, an MTC server may transmit the information that is usually included in an RRC Connection Request to the network 510 before or during the paging procedure.

In an embodiment, network 510 may send a single group RRC connection setup message to an MTC group 508. For example, the group RRC connection setup message may be addressed to the MTC WTRUs 502 in an MTC group 508. The group RRC connection setup message may include a field that may identify the MTC group 508. For example, the field may include a groupIMSI, an IMSI range or the like such that an MTC group 508 may be identified. The RRC connection setup message may indicate a configuration that the MTC WTRUs 502 in the MTC group 508 should use. The RRC connection setup message may indicate that the MTC WTRUs 502 may use a default configuration. Each MTC WTRU 502 may store information related to the default configuration. The default configuration may be different or the same for the MTC WTRUs 502 in the MTC group 508.

A group RRC connection setup message may assign group temporary identities to the MTC WTRUs 502 in the MTC group 508. For example, a group UTRAN Radio Network Temporary Identifier (U-RNTI), group Cell Radio Network Temporary Identifier (C-RNTI), group E-DCH Radio Network Temporary Identifier (E-RNTI), and/or other temporary identity information may be assigned to the MTC group 508.

The MTC WTRUs 502 in the MTC group 508 that receive a group RRC connection setup message may send an RRC connection setup complete message. In an embodiment, MTC WTRUs 502 in the MTC group 508 may send an RRC connection setup complete message individually. In an embodiment, a subset of the MTC WTRUs 502 may send an RRC connection setup complete message.

For example, the subset of MTC WTRUs 502 in the group that may send the RRC connection setup complete message may be determined. The determination may be based on, a configuration of the MTC WTRUs 502. For example, an MTC WTRU 502 may be configured with default information that may indicate whether the MTC WTRU 502 should send an RRC connection setup complete message. The default information may be stored by the MTC WTRU 502 in a SIM/USIM card, in a RAM, and/or in any processor-readable storage medium. For example, the determination may be based on one or more parameters in the RRC connection setup message. The parameters may be include, but not limited to, the individual IMSI of the MTC WTRU 502 and/or the device type of the MTC WTRUs 502 that may send the RRC connection setup complete message.

An RRC connection setup complete message may include one or more fields that may indicate whether the RRC connection setup complete message is an individual RRC connection setup complete message or a group RRC connection setup complete message. An individual RRC connection setup complete message may be sent by an MTC WTRU 502 on behalf of the particular WTRU. A group RRC connection setup complete message may be sent on behalf of an MTC group 508.

In an embodiment, the MTC WTRU 502 may include one or more group identifiers in a MAC header of a message send on a Dedicated Control Channel (DCCH) and/or Dedicated Transport Channel (DTCH). For example, the MAC header may include a groupU-RNTI and/or a groupC-RNTI. The MAC header may include one or more individual indexes for identifying individual MTC WTRUs 502. For example, each index may uniquely identify an MTC WTRU 502 in the MTC group 508. Indexes may be, for example, assigned to MTC WTRUs 502 as a pre-defined index. An index may be stored in a SIM/USIM card, in a RAM, and/or in any processor-readable storage medium. Network 510 may receive an RRC connection setup complete message, and may determine, based on the group identifiers and individual indices in the MAC headers, which MTC WTRU(s) 502 sent the RRC connection setup messages.

An RRC connection set up message may include a groupE-RNTI and an individual WTRU index in the MAC header. A message with these contents may be sent, for example, in an instance where an Enhanced Cell-Forward Access Channel (FACH) is used, and/or during a contention resolution phase of a FACH or RACH procedure. The groupE-RNTI and/or the individual WTRU index may be included within a MAC-i header in the RRC connection message. An MTC WTRU 502 may receive the groupE-RNTI and an individual index from the CN on a channel such as an Enhanced Access Grant Channel (E-AGCH).

In an embodiment, network 510 may send a group RRC connection setup message to the MTC WTRUs 502 in the MTC group 508. In an embodiment, network 510 may directly send a group RRC connection setup message without first transmitting a paging message. The MTC WTRUs 502 in the MTC group 508 may wake up at monitoring occasions to monitor a common channel for a predetermined period of time. The monitoring occasions may also include the MTC WTRUs 502 getting out of DRX periods. The MTC WTRUs 502 may monitor the common channel to determine whether one or more messages addressed to the MTC group 508 are transmitted on the channel. The monitoring occasions may correspond to paging occasions, may include a subset of paging occasions, and/or may be based on a different DRX pattern.

Though the example embodiments described herein are carried out in the context of IP address, it is to be understood that the technique applies to other network addresses. While the various embodiments have been described in connection with the various figures, it is to be understood that other similar embodiments may be used or modifications and additions may be made to the described embodiment for performing the same function of the various embodiments without deviating there from. Therefore, the embodiments should not be limited to any single embodiment, but rather should be construed in breadth and scope in accordance with the appended claims.

What is claimed:

1. A method for performing group-based machine-to-machine (M2M) communication, the method comprising:
receiving a paging message comprising a recipient international mobile subscriber identity (IMSI);
comparing the recipient IMSI to a first IMSI and a second IMSI associated with a machine-type communication (MTC) wireless transmit and receive unit (WTRU); and
processing the paging message when the recipient IMSI matches at least one of the first and second IMSIs.

2. The method of claim 1, wherein the first IMSI comprises an individual IMSI associated with the WTRU, and the second IMSI comprises a group-based IMSI associated with an MTC group comprising a plurality of MTC WTRUs.

3. The method of claim 2, further comprising:
determining a paging occasion based on the group-based IMSI.

4. The method of claim 2, wherein the paging message comprises a time period for the plurality of MTC WTRUs to transmit data, the method further comprising:
randomly selecting a value indicative of a transmission time associated with the WTRU inside of the time period; and
transmitting data during the transmission time.

5. The method of claim 2, wherein the paging message comprises a time period for the plurality of MTC WTRUs to transmit data, the time period comprising a plurality of sub-time periods, the method further comprising:
randomly selecting a sub-time period; and
transmitting data during the sub-time period.

6. The method of claim 2, wherein the paging message comprises a time period for the plurality of MTC WTRUs to respond to the paging message, the method further comprising:
selecting a random value between 0 and 1;
comparing the random value to a persistency value; and
determining whether to respond to the paging message based on an outcome of the comparing.

7. The method of claim 6, further comprising:
waiting for a predetermined time period;
selecting a second random value between 0 and 1;
comparing the second random value to the persistency value; and
determining whether to respond to the paging message based on an outcome of the comparing.

8. A method for performing group-based machine-to-machine (M2M) communication, the method comprising:
receiving a page comprising a recipient international mobile subscriber identity (IMSI) range;
comparing an IMSI associated with a machine-type communication (MTC) wireless transmit and receive unit (WTRU) to the recipient IMSI range; and
processing the page when the IMSI is within the recipient IMSI range.

9. The method of claim 8, wherein the recipient IMSI range comprises a starting IMSI, and an ending IMSI.

10. The method of claim 8, wherein the recipient IMSI range correspond to an MTC group comprising a plurality of MTC WTRUs.

11. The method of claim 10, further comprising:
determining a paging occasion associated with the MTC group based on an IMSI within the recipient IMSI range.

12. The method of claim 10, further comprising:
determining a paging occasion associated with the MTC group based on a medium IMSI within the recipient IMSI range.

13. A machine-type communication (MTC) wireless transmit and receive unit (WTRU) configured to perform group-based machine-to-machine communication, the WTRU being part of an MTC group comprising a plurality of MTC WTRUs, the WTRU comprising:
a memory configured to:
store an individual international mobile subscriber identity (IMSI); and
store a group-based IMSI;
a transceiver configured to:
receive a paging message comprising a recipient IMSI; and
a processor configured to:
compare the recipient IMSI to the individual IMSI and the group-based IMSI; and
process the paging message when the recipient IMSI matches at least one of the individual IMSI and the group-based IMSI.

14. The WTRU of claim 13, wherein the processor is further configured to:
determine a paging occasion based on the group-based IMSI.

15. The WTRU of claim 13, wherein the paging message comprises a time period for the plurality of MTC WTRUs to transmit data and the processor is further configured to:
select a random value;
determine a sub-time period associated with the WTRU inside of the time period based on the random value; and
wherein the transceiver is further configured to transmit data during the sub-time period.

16. The WTRU of claim 13, wherein the paging message comprises a time period for the plurality of MTC WTRUs to respond to the paging message, the time period comprising a plurality of sub-time periods, and the processor is further configured to randomly select a sub-time period, and wherein the transceiver is further configured to respond to the paging message during the sub-time period.

17. The WTRU of claim 13, wherein the paging message comprises a time period for the plurality of MTC WTRUs to transmit data and the processor is further configured to:
select a random value between 0 and 1;
compare the random value to a persistency value; and
determine whether to transmit data based on an outcome of the comparing.

18. The WTRU of claim 17, wherein the processor is further configured to:
wait for a predetermined time period;
select a second random value between 0 and 1;
compare the second random value to the persistency value; and
determine whether to transmit data based on an outcome of the comparing.

19. The WTRU of claim 13, wherein the processor is further configured to:
based on a determination that the recipient IMSI matches the group-based IMSI, determining whether to respond to the paging message.

20. The WTRU of claim 13, wherein the processor is further configured to:
based on a determination that the recipient IMSI matches the group-based IMSI, determining whether to send a connection request.
